(19) United States
(12) Patent Application Publication
(10) Pub. No.: US 2006/0162517 A1
(43) Pub. Date: Jul. 27, 2006

(54) Apparatus and method for moving logs withing cutting-off machines

(76) Inventor: Fabio Perini, Viareggio (IT)

Correspondence Address: MCGLEW & TUTTLE, PC, P.O. BOX 9227, SCARBOROUGH STATION, SCARBOROUGH, NY, 10510-9227, US

(21) Appl. No.: 10/547,435

(22) PCT Filed: Mar. 22, 2004
(86) PCT No.: PCT/IT04/00139

§ 371 Date: Aug. 25, 2005

(30) Foreign Application Priority Data
Apr. 24, 2003 (IT) FI2003 A 000115

(51) Int. Cl. B26D 7/06

(52) U.S. Cl. 83/37; 83/330; 198/626.1

(57) ABSTRACT

Apparatus for moving logs (2) within cutting-off machines, comprising a platform (1) with one or more longitudinal channels (10) inside which the logs to be cut are disposed, and pusher means (3) acting in correspondence of said platform (1) and intended for acting on the back of the logs (2) to push them, along respective guide channels (10), toward cutting means (4) disposed downstream, apparatus characterized in that it comprises clamping means (5) disposed intermediate between said pusher means (3) and said cutting means (4) and intended for engaging the logs (2) which are pushed along the channels (10) of platform (1) by the pushers (3) and driving them along up to said cutting means (4).

The present invention-refers to an apparatus and a method for moving logs within cutting-off machines.

In the following text, the term “logs” is meant to indicate rolls of web material (such as paper) wound up around a support core (for example, a tubular cardboard core), to be cut to form rolls of smaller length, that is, of commercial size.

The production of paper rolls is known to involve cutting transversally the logs, produced by a rewinding machine, by using one or more cutting-off machines.

A cutting-off machine for logs is described in details in the patent IT 1247330.

Essentially, a cutting-off machine of this type comprises:

a plurality of channels or guides into which the logs are discharged and in correspondence of which movable devices, so-called “porters” in jargon, are mounted to drive the logs into longitudinal motion by pushing them from behind;

a cutting station, comprising one or more circular blades, rotating about axes parallel to those of the logs and fixed on a corresponding movable support.

During the normal operation, a log to be cut is disposed, by a relevant porter, in a preset position on the respective guide and blocked in such position; then, one of the blades is actuated, that is, it is driven into a plane orthogonal to the axis of the log, so as to form a shorter roll of preset size therefrom. The length of the roll depends, actually, on the advancement of the porter during the time elapsing between two consecutive cuts operated by the blades.

In particular, the feeding of the logs to the cutting means is of discontinuous nature, as an empty space results all the time between one log and the next, and because it is in fact impossible to use the system with porters of known type to feed the logs continually.

Such discontinuity in the supply brings about a decreased production, in terms of number of rolls per hour being produced, with respect to the actual capacity of the system.

A further drawback is that the components of the system are likely to collide with each other in case of failures in the system predisposed for moving the porters and the cutting means in synchronism, which affects negatively the economy of the manufacturing process.

The main object of the present invention is to overcome the said drawbacks.

This result has been achieved, according to the invention, by adopting the idea of a structure and a method having the characteristics described in independent claims. Further characteristics being set, forth in the dependent claims.

The present invention makes it possible to continuously feed the logs to cutting means, with no interruptions nor empty spaces between consecutive logs, which allows improving significantly the actual output of the system and without any interference between the means for driving the logs and the cutting means. Moreover, an apparatus according to the invention is relatively easy to make, cost-effective and reliable even after a prolonged service life.

These and other advantages and characteristics of the invention will be best understood by anyone skilled in the art from a reading of the following description in conjunction with the attached drawings given as a practical exemplification of the invention, but not to be considered in a limitative sense, wherein:

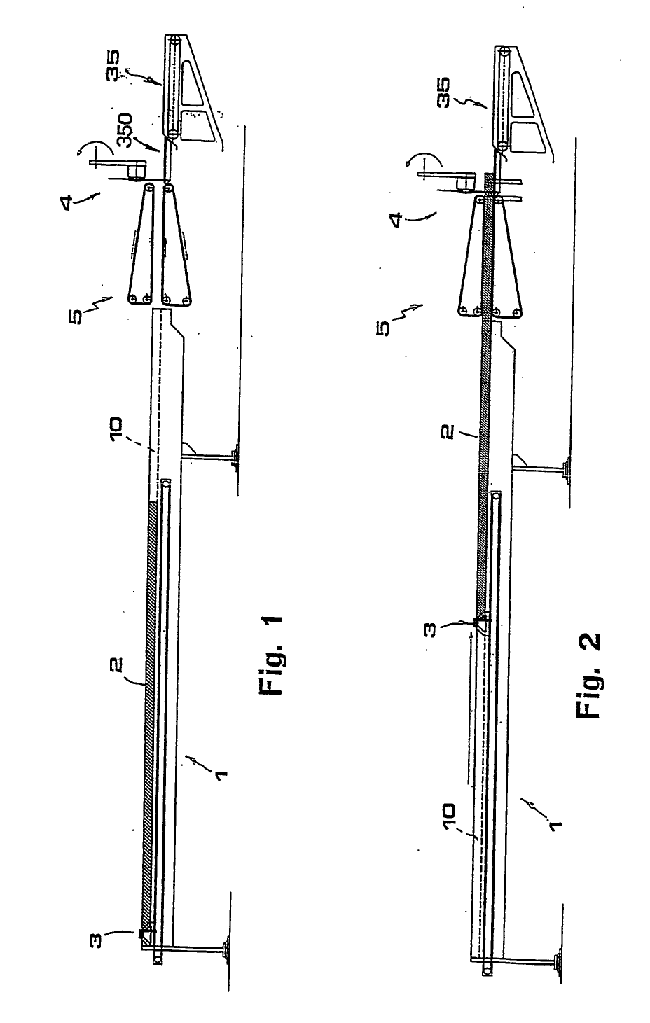

FIG. 1 is a schematic side view of an apparatus, according to the invention, showing the step at the beginning of a work cycle;

FIG. 2 shows the apparatus of FIG. 1 with a log engaged by clamping means and subjected to a cutting operation;

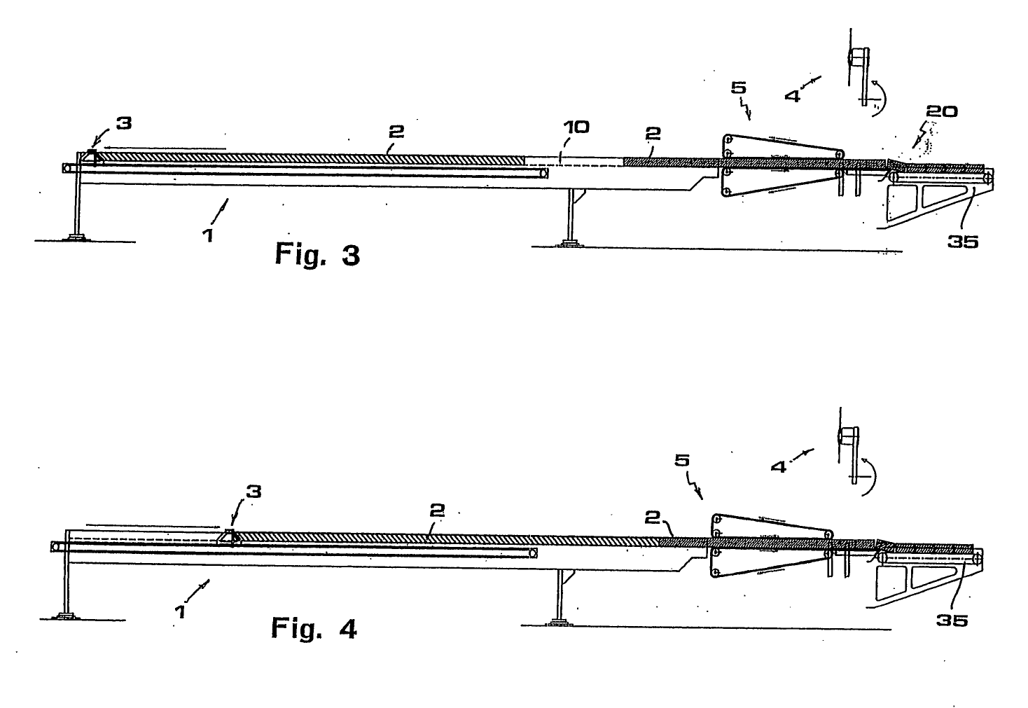

FIG. 3 shows the apparatus of FIG. 1 with another log loaded onto the respective channel of the platform for the sliding of the logs;

FIG. 4 shows the apparatus of FIG. 1 with two logs lined up one after the other;

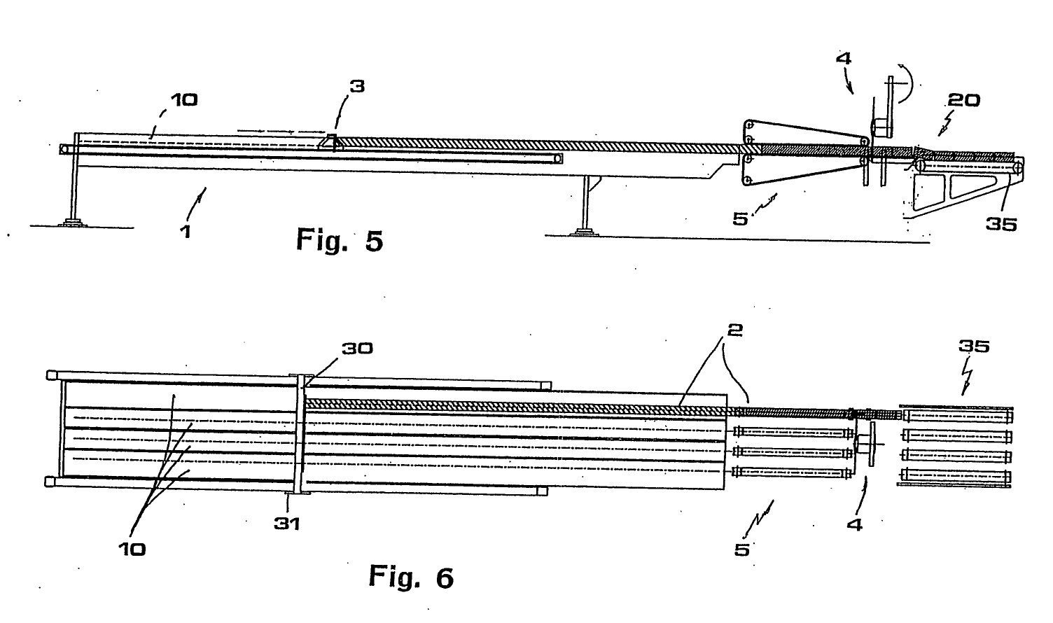

FIG. 5 shows the apparatus of FIG. 4 with the second log having its head section positioned between the clamping means;

FIG. 6 shows a plan view of the apparatus of FIG. 5;

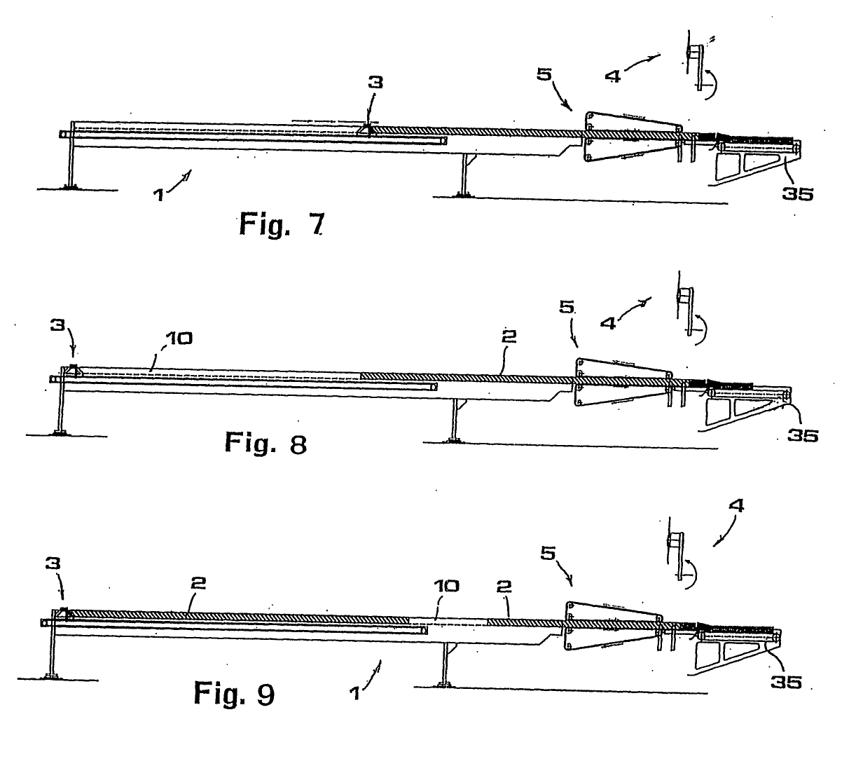

FIGS. 7 and 8 show the same apparatus in two operating steps that follow the one represented in FIG. 6;

FIG. 9 shows also the same apparatus in a further step, with another log loaded on the platform;

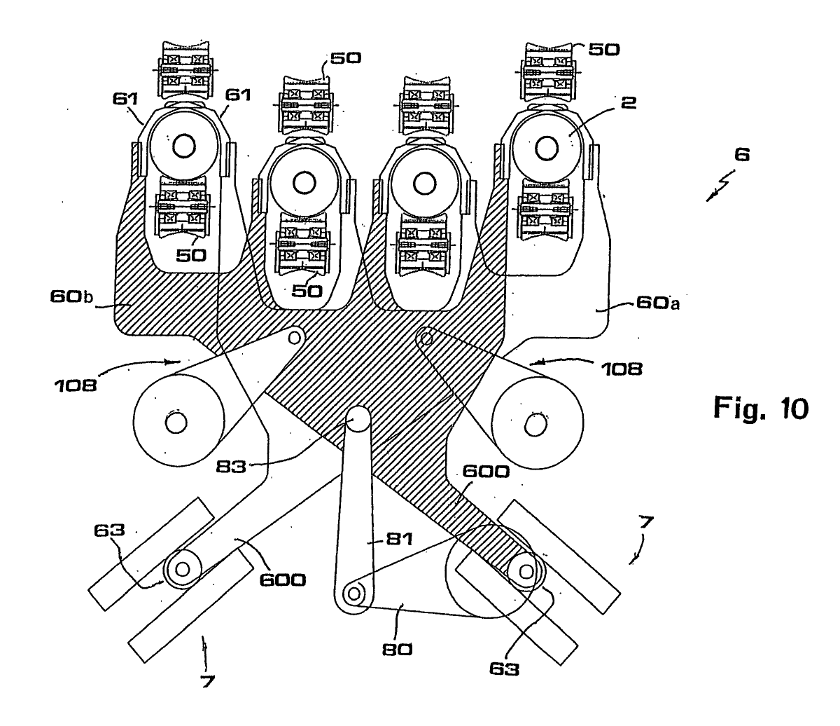

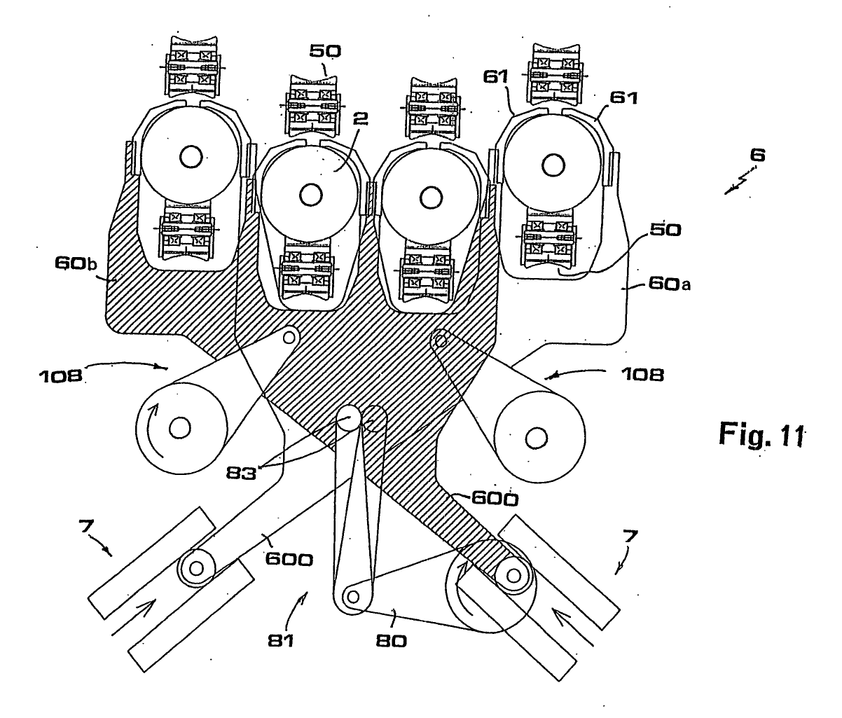

FIGS. 10 and 11 are schematic front views of the configurations taken up by the means for the temporary retention of logs of different diameter in the cutting-off station, respectively;

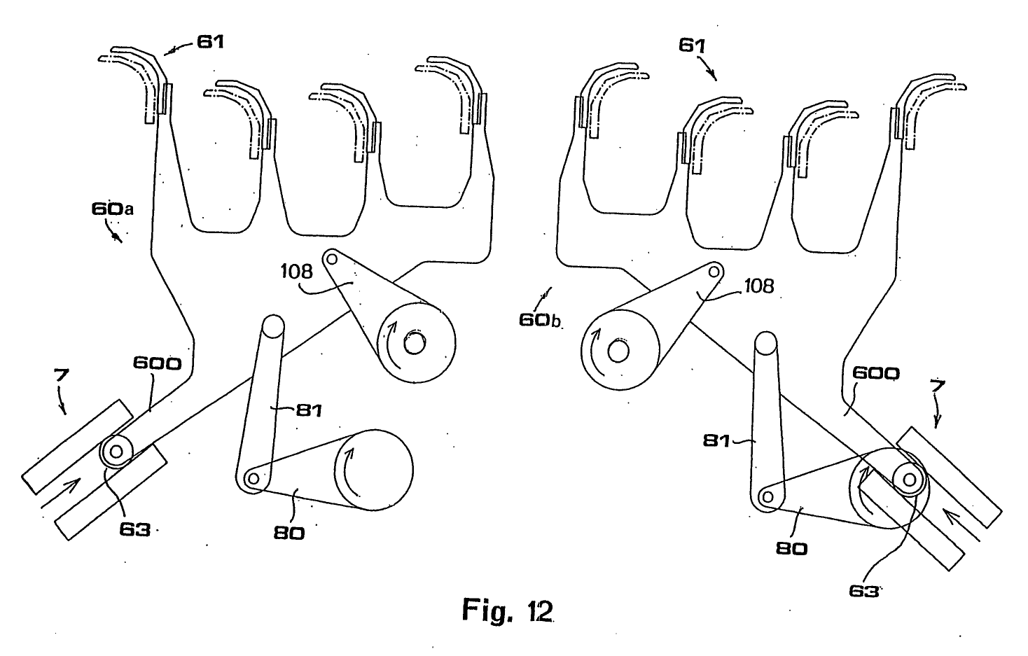

FIG. 12 is a schematic exploded side view of the retention means illustrated in FIGS. 10 and 11;

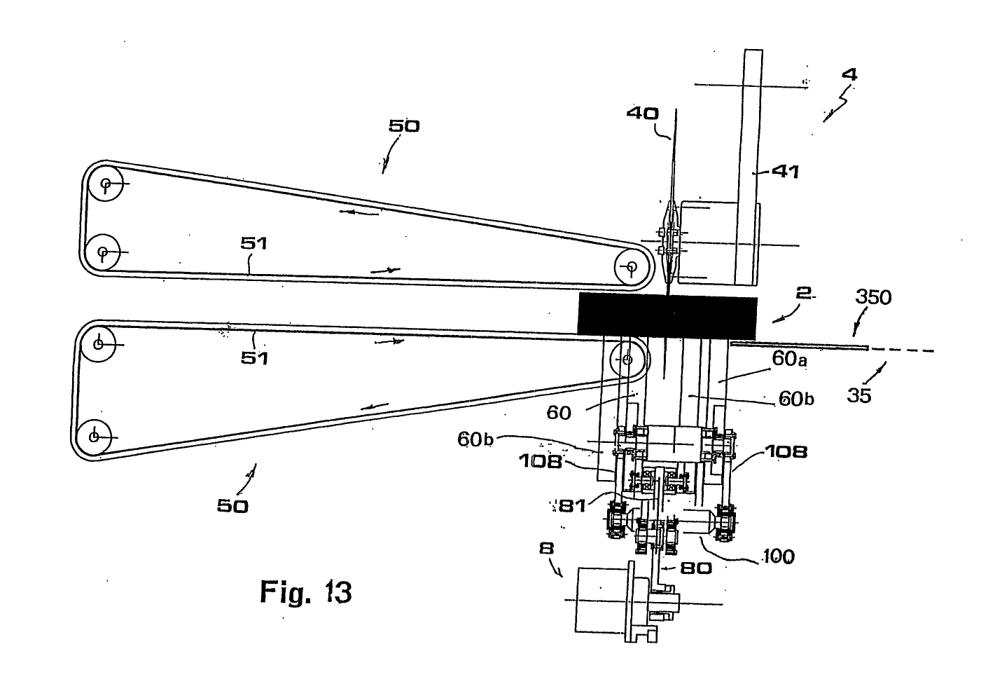

FIG. 13 is a schematic side view of the retention means illustrated in FIGS. 10 and 11;

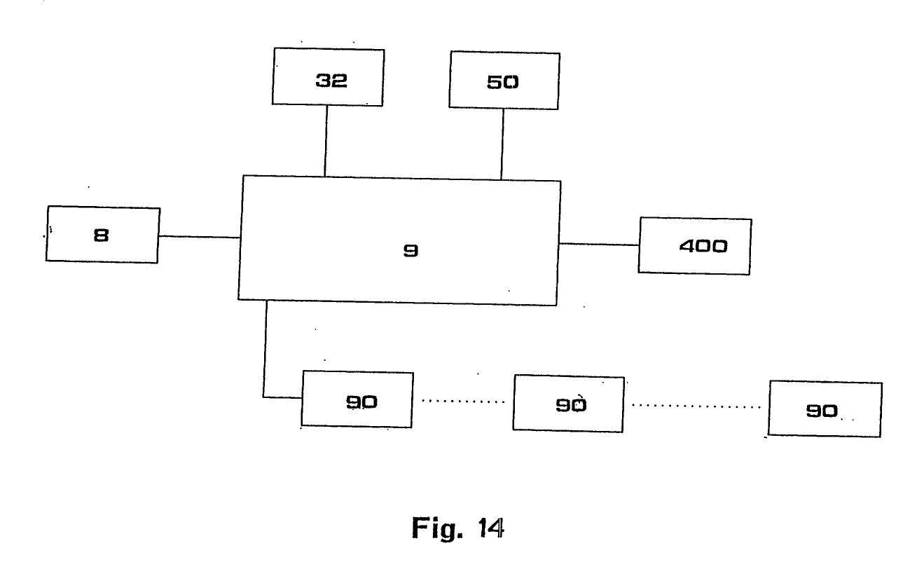

FIG. 14 is a simplified block diagram of the automatic drive and control means.

Reduced to its basic structure, and reference being made to the figures of the attached drawings, an apparatus according to the invention comprises:

a platform (1) with one or more longitudinal channels (10) inside which the logs to be cut are disposed;

pusher means (3) acting in correspondence of said platform (1) and intended for acting on the back of the logs (2) to push them, along respective guide channels (10), toward cutting means (4) disposed downstream;

clamping means (5) disposed intermediate between said pusher means (3) and said cutting means (4) and intended for engaging the logs (2) which are pushed along the channels (10) of platform (1) by the pushers (3) and driving them along as far as said cutting means (4).

Advantageously, the said pusher means (3) comprise a bar (30) disposed transverse to the channels (10) of platform (1) and moved to and from the said clamping means (5) by a carriage (31) associated with a corresponding electric motor (32) (shown only in the block diagram of FIG. 14) and mounted for sliding on the two long sides of platform (1).

Moreover, advantageously, the said clamping means (5) are made up of two motor-driven, loop-closed belts (50) disposed opposite to each other, with respect to the plane (2) on which the logs (2) arrive sliding on the platform (1), so that each belt will always exhibit a length (51) parallel to such plane: the lengths facing each other (51) of said belts (50) being spaced apart of an extension substantially equal to the outer diameter of the logs (2).

For example, reference being made to the attached drawings, the said cutting means (4) comprise a blade (40) mounted on a support arm (41) which is associated with a relevant actuator (400) (see block diagram of FIG. 14) to drive it into motion from and to the logs (2) to be cut.

The operation of the above described apparatus is as follows. The logs (2) are disposed in the channels (10) of platform (1) by automatic loading devices (known to those skilled in the art and, therefore, not to be described herein in details), and the pusher means (3) provide for pushing them toward the belts (50) as far as between the parallel lengths (51) of the latter (FIGS. 1 and 2). At this point, each log (2) thus positioned results retained between the same belts (50) which, by rotating on respective driving-out rollers, direct the log toward the cutting means (4), as illustrated in FIG. 3, and engage the same log on diametrically opposite surface portions thereof. The movement of the belts (50) and thus of logs (2), is intermittent and in synchronism with the cutting means (4): in correspondence of each dwell, the means (4) are active, so that the logs (2) are cut, whereas during the movement of belts (50) the means (4) are inoperative and away from the logs (2). The speed and time of operation of the belts (50) are predetermined in relation to the length of paper rolls (20) to be obtained from the cutting of the logs (2). Once the logs (2) are held between the belts (50), the carriage (31) moves back to take up the relevant initial position, so that, when disposing further logs (2) in the channels of platform (1), these logs can be driven, again by the same pusher means, as far as to dispose the relevant head portions thereof in contact with the tail sections of the logs (2) previously handed over to the belts (50), as illustrated in FIG. 4. This process is cyclically repeated, as illustrated also in FIGS. 5-9. It thus follows that the feeding of the logs (2) to the cutting means is performed continuously, that is, without interruptions or empty spaces between consecutive logs, with evident advantages in terms of actual production of the system. The rolls, as they are produced, (20) are pushed by the same logs (2) being treated onto a conveyor belt (35) located downstream of the cutting means (4) which provides for moving them away. Possibly disposed between the conveyor belt (35) and the cutting means (4) is a stationary horizontal plane (350).

An operating method according to the invention includes, therefore, a step of push-operated longitudinal movement of the logs (2) to be cut, and a subsequent step of pull-operated longitudinal movement of the same logs (2).

The method in question may be carried out, for example, by means of the previously described apparatus and allows a continual feed of logs (2) to be obtained owing to the combination of said push and pull actions on the logs (2).

When trimmed logs are loaded onto the platform (1), it is also possible to obtain a more uniform cut quality from the first to the last of the rolls obtained from each log. It is also possible to move the belts (50) in such a manner to perform a double step of the latter when there is the passage of the tailing section of a log and of the heading section of the subsequent log in correspondence of the cutting means (4). In this case, a trimming of the logs is not to be provided (whereas, on the contrary, it is normally provided for not trimmed logs). Use of trimmed logs contributes to further increase the production.

Advantageously, in correspondence of the cutting means (4), further means (6) may be provided intended for temporarily retaining the logs (2) during the cutting step, that is, when the cutting means are activated.

The said retention means (6), according to the exemplary embodiment illustrated in the figures of the attached drawings, comprise two plates (60a, 60b) each of which exhibits, on one side, a plurality of rigid, substantially semicircular hooks—hereinafter referred to as “pressers”—and, on the opposite side, an appendix (600) slidingly fitted within a guide (7) inclined at a predetermined angle to the vertical: the said plates (60a, 60b) being associated with an actuator (8) which, under control, drive them into a substantially rectilinear motion in the direction of the respective guides (7), and the same plates being disposed in parallel and mirror-like relationship, that is, orthogonally to the logs (2) to be treated.

The appendixes (600) of said plates (60a, 60b) are provided with small rollers (63) to assist the sliding thereof within the respective guides (7).

Preferably, the said guide (7) is inclined at an angle of 60° to 65° to the vertical in order to achieve what it is deemed to be an optimal combination of vertical and horizontal components of the displacement of each presser (61), and to allow the apparatus to work as best as possible whatever the diameter of the logs under treatment, thus resulting extremely versatile.

For example, the said actuator (8) may be an electric motor connected to the two plates (60a, 60b) via a transmission device of crank-connecting rod type (80, 81) acting on pivots (83) going through the two plates (60a, 60b): the said plates (60a, 60b) being engaged to a fixed body (100) via corresponding levers (108) each of which, on one side, is hinged to one of the two fixed bodies (100) and, on the other side, is hinged to one of the two plates (60a, 60b) above said pivots (83). The axes of the hinges, connecting the levers (108) with the plates (60a, 60b), being parallel to the pivots (83).

When the cutting means (4) are inoperative and away from logs (2), the plates (60a, 60b) are lifted (as shown with dashed line in FIG. 12) so that the logs (2) result free of translating forwards (owing to the pull exerted thereon by the said belts 50). Just before the beginning of the step for the cutting of logs (2), that is, when these result in cutting position, the plates (60a, 60b) are lowered (see FIGS. 10 and 11 and the drawing with solid lines in FIG. 12) by compressing the surface of the logs by means of the hooks (61) which, being approximately semicircular and in mirror-like relationship, embrace the logs laterally and on top as well, thereby retaining them in the preset position. At the bottom, the logs (2) rest in part on respective belts (50) and in part on the plane (350). The lowering and lifting of the plates (60a, 60b) is caused by the actuator (8) via the array of levers above mentioned.

The controls of pusher means (3), clamping means (5), cutting means (4) and actuator (8), the latter operating the translation of plates (60a, 60b), are all automated via corresponding programmable electronic means to which optical, photocell-operated, control means (90) are also connected, the latter being disposed along the operative path of the logs (2) at known and preset positions. Such electronic means are known to those skilled in the industrial automation field and will not, therefore, be described in greater detail.

Practically, the construction details may vary in any equivalent way as far as the shape, dimensions, elements disposition, nature of the used materials are concerned, without nevertheless departing from the scope of the adopted solution idea and, thereby, remaining within the limits of the protection granted to the present patent.

1. Apparatus for moving logs within cutting-off machines, comprising a platform with one or more longitudinal channels inside which the logs to be cut are disposed, and pusher means acting in correspondence of said platform and intended for acting on the back of the logs to push them, along respective guide channels, toward cutting means disposed downstream, apparatus characterized in that it comprises clamping means disposed intermediate between said pusher means and said cutting means and intended for engaging the logs which are pushed along the channels of platform by the pushers and driving them along up to said cutting means.

2. Apparatus according to claim 1, characterized in that the said pusher means comprise a bar disposed transverse to the channels of platform and moved to and from the said clamping means by a carriage associated with a corresponding electric motor and mounted for sliding on the two long sides of platform.

3. Apparatus according to claim 1, characterised in that said clamping means comprise motor-driven, loop-closed belts disposed opposite to each other, with respect to the plane on which the logs arrive sliding on the platforms, so that each belt will always exhibit a length parallel to such plane: the lengths facing each other of said belts being spaced apart of an extension substantially equal to the outer diameter of the logs.

4. Apparatus according to claim 1, characterized in that, in correspondence of said cutting means, further means may be provided intended for temporarily retaining the logs during the cutting step, that is, when the cutting means are activated.

5. Apparatus according to claim 1, characterized in that the said retention means comprise two plates each of which exhibits, on one side, a plurality of rigid, substantially semicircular hooks and, on the opposite side, an appendix slidingly fitted within a guide inclined at a predetermined angle to the vertical: the said plates being associated with an actuator which, under control, drive them into a substantially rectilinear motion in the direction of the respective guides, and the same plates being disposed in parallel and mirror-like relationship, that in, orthogonally to logs to be treated.

6. Apparatus according to claim 5, characterized in that the said guide is inclined at an angle of 60° to 65° to the vertical.

7. Method for moving logs within cutting-off machines, characterized in that it comprises a step of push-operated longitudinal movement of the log to be cut by means of pusher means acting on the back of the logs to be cut, to push them toward cutting means disposed downstream, and a subsequent step of pull-operated longitudinal movement of the same logs by means of clamping means, wherein the logs which are pushed by pusher means are engaged and driven up to said cutting means.

8. Method according to claim 7, characterized in that the movement of the logs is continuous, with the head of each log resulting in contact with the tail of the preceding log.

9. Method according to claim 7, characterized in that said logs are trimmed logs, i,e. logs which are trimmed before to be submitted to said push and pull operations.

10. Apparatus according to claim 4, characterized in that the said retention means comprise two plates each of which exhibits, on one side, a plurality of rigid, substantially semicircular hooks and, on the opposite side, an appendix slidingly fitted within a guide inclined at a predetermined angle to the vertical: the said plates being associated with an actuator which, under control, drive them into a substantially rectilinear motion in the direction of the respective guides, and the same plates being disposed in parallel and mirror-like relationship, that in, orthogonally to logs to be treated.
